(19) United States
(12) Patent Application Publication
(10) Pub. No.: US 2006/0130035 A1
(43) Pub. Date: Jun. 15, 2006

(54) METHOD AND CHIP FOR UPGRADING FLASH ROM OF OPTICAL DISK DRIVE

(76) Inventors: Chun-Hung SHIH, Taipei City (TW); Yu-Shu CHIEN, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/905,429

(22) Filed: Jan. 4, 2005

(30) Foreign Application Priority Data
Nov. 23, 2004 (TW) 093136037

(51) Int. Cl. G06F 9/44

(52) U.S. Cl. 717/168

(57) ABSTRACT

A method for upgrading a flash ROM of an optical disk drive and a chip for performing the method. The method includes sending an activating program to a first scratch pad memory, sending a firmware data to a second scratch pad memory, utilizing a microprocessor to load the activating program from the first scratch pad memory for upgrading the firmware sequence, and the upgraded firmware sequence records the firmware data stored in the second scratch pad memory into a flash ROM.

### BACKGROUND OF INVENTION

1. Field of the Invention

The present invention relates to a method and chip for upgrading firmware, and more particularly, to a method and chip for upgrading the firmware of an optical disc drive.

2. Description of the Prior Art

As standards for disc recording systems continue to advance, consumers are able to record larger volumes at faster recording speeds and in more diverse recording formats. Also, blank recordable discs and data format types continue to emerge with new innovations, with both criteria continuing to form a high priority requirement. At the moment, disc recording devices often require users to upgrade their firmware data in order to upgrade their functions to give more format support and improve on media compatibility.

Please refer to FIG. 1. FIG. 1 illustrates a diagram of a prior art optical disc drive 100 coupled to a computer system 20 and a disc 19. Chip 10 is the controller of the optical disc drive 100 and is used to execute a firmware upgrade program. The chip 10 comprises a controller 11, a microprocessor 12, and a decoder 13. The prior art optical disc drive 100 further comprises a buffer 16 and a flash ROM 18 coupled through an internal bus to the chip 10. The optical disc drive 100 also reads data from the disc 19 through a radio-frequency amplifier and controller 15. The optical disc drive 100 is also coupled to a motherboard interface 17 which is also coupled to a computer system 20.

In the prior art optical disc drive 100, data read from the disc 19 is transmitted through the motherboard interface 17 to the computer system 20 for processing. During recording, data transmitted from the computer system 20 to the motherboard interface 17 is recorded on the disc 19, and the chip 10 controls all operations. When the computer system 20 is processing data from the disc 19 transmitted through the motherboard interface 17, the microprocessor 12 will obtain related instructions from the firmware data stored in the flash ROM 18. These instructions control the radio-frequency amplifier and controller 15 for reading the data of the disc 19 and for commanding the controller 11 to transmit the signal received by the radio-frequency amplifier and controller 15 to the decoder 13 to begin decoding. Data decoded by the decoder 13 will be stored temporarily into the buffer 16 and will be transmitted to the computer system 20 through the motherboard interface 17.

When the prior art optical disc drive 1 00 records data onto the disc 19, the computer system 20, through the motherboard interface 17, first stores the data into the buffer 16, and then the microprocessor 12 sends the data to the decoder 13 for decoding and transmits the data to the controller 11 according to the related instructions of the firmware data of the flash ROM 18, and commands the controller 111 to control the radio-frequency amplifier and controller 15 to record the data onto the disc 19.

Most of the firmware data of the optical disc drive is recorded in the flash ROM when manufactured, therefore when the users updates the predetermined firmware data of the flash ROM, a particular firmware program is needed to upgrade the current firmware data of the flash ROM. An activating program is also stored in the flash ROM when manufactured for upgrading the predetermined firmware data. The firmware program of the prior art optical disc drive is sent out by command of the computer system, and the chip of the optical disc drive then executes the activating program for upgrading from the flash ROM itself.

In the process of upgrading the firmware of the optical disc drive, the data obtained is recorded into the flash ROM where the activating program and the predetermined firmware data are stored. As the activating program and the predetermined firmware data are placed in the same flash ROM, if there is an error during the process of upgrading, such as a power failure, incompatibility, operation error, or system crash, this will cause errors in the firmware data. An incomplete upgrade will cause the predetermined firmware data to be corrupted. In a worse situation, the error may damage the activating program in the flash ROM, causing the optical disc drive unable to further perform upgrading, or may be completely unusable. In this situation, the optical disc drive has to be sent back to the original manufacturer for re-installation of the original firmware data. These disadvantages and risks in the prior art optical disc drive cause major inconvenience for the users.

### SUMMARY OF INVENTION

One embodiment of the claimed invention is a method of upgrading an optical disc drive for storing an activating program during the upgrading process into a scratch pad memory, other than a flash ROM, and using the computer system, rather than the microprocessor of the optical disc drive, for controlling the firmware upgrade program, to solve the problems mentioned above when upgrading the predetermined firmware program.

One preferred embodiment of the claimed invention comprises a method for upgrading the optical disc drive; sending an activating program to a first scratch pad memory; sending a firmware data to a second scratch pad memory; a micro-processor loading the activating program read from the first scratch pad memory to perform a firmware upgrade program; and the firmware upgrade program storing the firmware data of the second scratch pad memory into a flash ROM.

One preferred embodiment of the claimed invention comprises a chip for upgrading the optical disc drive; a scratch pad memory comprising an activating program; and a logic unit for loading the activating program from the scratch pad memory to perform a firmware upgrade program and store firmware data into a flash ROM.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a prior art diagram of an optical disc drive.

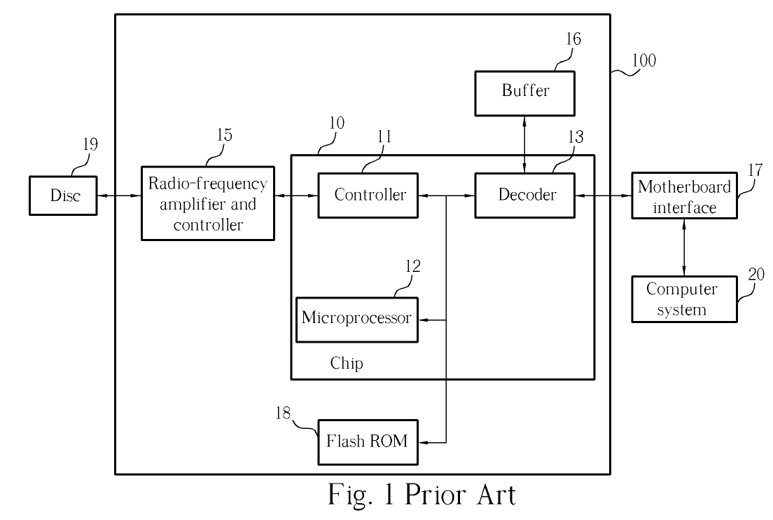

FIG. 2 illustrates a diagram of an optical disc drive according to an embodiment of the present invention.

FIG. 3 illustrates a flowchart of the method of upgrading an optical disc drive.

### DETAILED DESCRIPTION

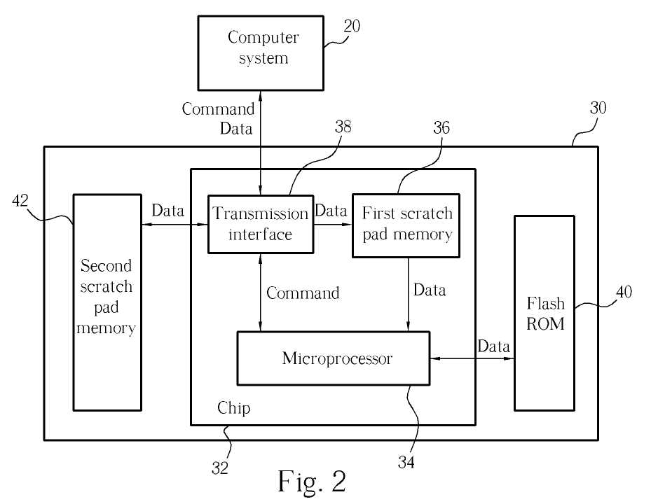

Please refer to FIG. 2. FIG. 2 illustrates a diagram of an optical disc drive 30 coupled to a computer system 20. The optical disc drive 30 comprises a chip 32 for controlling operations of the optical disc drive 30 and for executing upgrading firmware commands, a flash ROM 40 for storing firmware data and for executing an activating program for upgrading the firmware, and a second scratch pad memory 42, coupled to the chip 32 through a bus, acting as a temporary storage for the firmware data during the process of upgrading the firmware program. In the optical disc drive 30 of the claimed invention, the second scratch pad memory 42 is coupled to the chip 32, and the chip 32 is coupled to the flash ROM 40 through a bus to provide high-speed access to storage when upgrading firmware. The chip 32 comprises a microprocessor 34, a first scratch pad memory 36, and a transmission interface 38. The microprocessor 34, the scratch pad memory 36, and the transmission interface 38 are coupled to each other; the transmission interface 38 is coupled to the second scratch pad memory 42; and the microprocessor 34 is coupled to the flash ROM 40. The microprocessor 34 controls the optical disc drive 30 and executes the activating program when the optical disc drive upgrades its firmware. During the upgrading of the firmware program, the microprocessor 34 loads the activating program from the first scratch pad memory 36 of the chip 32 to execute the firmware upgrade. The transmission interface 38 acts as a communication interface between the chip 32 and the computer system 20. When executing the firmware upgrade program of the optical disc drive 30, the computer system 20 transmits a command through the transmission interface 38 that coordinates with the transmission interface 38 to perform the firmware upgrade program.

Also, in the optical disc drive 30, the first scratch pad memory 36 installed within the chip 32 is being used for storing the activating program, and the microprocessor 34 then loads the activating program to perform the firmware upgrade program.

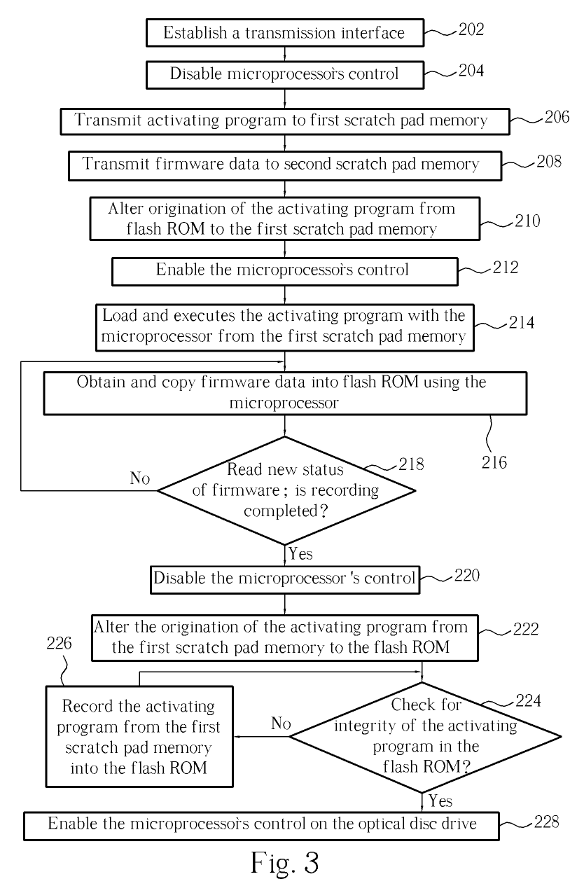

Please refer to FIG. 3. FIG. 3 illustrates the flowchart of the method of upgrading the optical disc drive 30. The method comprises the following steps:

Step 202: Establish a transmission path;

Step 204: Disable the microprocessor's control on the optical disc drive;

Step 206: Transmit the activating program from the computer system through the transmission interface to the first scratch pad memory within the chip of optical disc drive;

Step 208: Transmit the firmware data from the computer system through the transmission interface to the second scratch pad memory within the optical disc drive;

Step 210: Alter the origination of the activating program from the flash ROM to the first scratch pad memory;

Step 212: Enable the microprocessor's control on the optical disc drive;

Step 214: The microprocessor loads and executes the activating program from the first scratch pad memory;

Step 216: The microprocessor obtains and copies the firmware data into the flash ROM;

Step 218: Read the new status of the optical disc drive firmware; if the status of the firmware is shown completed, then execute step 220; if not, execute step 216;

Step 220: Disable the microprocessor's control on the optical disc drive;

Step 222: Alter the origination of the activating program from the first scratch pad memory to the flash ROM;

Step 224: Check for the integrity of the activating program in the flash ROM; if positive, execute step 228; otherwise, execute step 226;

Step 226: Record the activating program from the first scratch pad memory into the flash ROM;

Step 228: Enable the microprocessor's control on the optical disc drive.

In step 210, the upgrade program transmits the transmission interface instruction through the transmission interface 38 to command the microprocessor 34 of the chip 32 of the optical disc drive 30 to alter where the activating program is loaded from the flash ROM 40 to the first scratch pad memory 36 of the chip 32. Hence, during the process of upgrading, the microprocessor 34 loads the activating program from the first scratch pad memory 36 instead of the flash ROM 40. And as described in step 206, the to-be-loaded activating program is transmitted by the computer system 20 through the transmission interface 38 during the process of upgrading.

In the present invention, the flash ROM 40 can be a flash ROM or an electrically erasable programmable read only memory (EEPROM). The second scratch pad memory 42 can be a dynamic random access memory (DRAM) or a cache memory, and the transmission interface 38 in the chip 32 can be a RS232 interface, an integrated drive electronics (IDE) interface, an enhanced IDE (EIDE), an small computer system interface (SCSI), or a serial advanced technology attachment (ATA) interface. The transmission interface 38 transmits a command that coordinates with the standards that the transmission interface 38 uses, such as RS232 commands, IDE commands, EIDE commands, SCSI commands, and serial ATA commands (in accordance with the standards of the transmission interface 38) to perform the firmware upgrading program. Also, the first scratch pad memory 36 can be a DRAM or cache memory.

In all the bused between the components mentioned above, which are coupled to the optical disc drive 30, the computer system 20 and the transmission interface 38 can transmit DATA (i.e., firmware data or an activating program, likewise as followed) and COMMANDS (i.e., a transmission interface command, likewise as followed) in both ways. The transmission interface 38 and the second scratch pad memory 42 can also transmit DATA in both ways. The microprocessor 34 and the flash ROM 40 can also transmit DATA in both ways. The transmission interface 38 and the microprocessor 34 can transmit COMMANDS in both ways. The transmission interface 38 can only transmit DATA to the first scratch pad memory 36, likewise, the first scratch pad memory 36 can only transmit DATA to the microprocessor 34.

A difference between the upgrading method of the optical disc drive 30 of the present invention and the upgrading method of the prior art optical disc drive is that the upgrading process is fully controlled by the computer system 20. Through the upgrade program, the computer system 20 sends out commands to control the optical disc drive 30 for upgrading its firmware data. In the process of upgrading, the present invention allows the flash ROM 40 of the optical disc drive 30 to be blank while processing an upgrade; the reason is that the method of the present invention does not rely on any data in the flash ROM. If an error occurs, such as a power failure, operation error, or system crash, which causes the upgrading process to halt, the firmware data in the flash ROM will be corrupted and the activating program may also be destroyed. Hence, according to steps 202 and 204 shown in FIG. 3, the control of the optical disc drive 30 by the microprocessor 34 can be shifted to the upgrade program of the computer system 20. Therefore, the upgrade program of the computer system 20 can easily execute the firmware upgrade program again without being affected by the corrupted content of the flash ROM. In comparison with the upgrading method of the prior art optical disc drive, wherein when the flash ROM receives data to execute a new command but the upgrade program cannot proceed due to the damaged flash ROM data, the present invention is capable of overcoming this problem efficiently.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for upgrading an optical disc drive comprising the following steps:
sending an activating program to a first scratch pad memory;
sending a firmware data to a second scratch pad memory;
loading the activating program read from the first scratch pad memory to perform a firmware upgrade program using a microprocessor; and
storing the firmware data of the second scratch pad memory into a flash ROM by executing the firmware upgrade program.

2. The method of claim 1 further comprising:
disabling the control from the microprocessor.

3. The method of claim 1 further comprising:
altering the origination of the activating program from the flash ROM to the first scratch pad memory.

4. The method of claim 1 further comprising:
altering the origination of the activating program is loaded from the first scratch pad memory to the flash ROM.

5. The method of claim 1 further comprising:
detecting an execution condition of storing the firmware data of the second scratch pad memory into a flash ROM by executing the firmware upgrade program.

6. The method of claim 1 further comprising:
setting up a transmission interface.

7. The method of claim 6 wherein the transmission interface is selected from the group consisting of an RS232 interface, an integrated drive electronics (IDE) interface, an enhanced IDE (EIDE) interface, an small computer system interface (SCSI), and a serial advanced technology attachment (ATA) interface.

8. The method of claim 6 wherein the activating program is transmitted to the first scratch pad memory via the transmission interface.

9. The method of claim 6 wherein the firmware data is transmitted to the second scratch pad memory via the transmission interface.

10. An optical disc drive, comprising:
a flash ROM for storing firmware data;
a chip, comprising:
a first scratch pad memory for storing an activating program; and
a logic unit for loading the activating program from the first scratch pad memory for performing a firmware upgrade program and storing firmware data into the flash ROM; and
a second scratch pad memory for acting as a temporary storage for the firmware data during the process of upgrading the firmware program.

11. The optical disc drive of claim 10 further comprising:
a transmission interface for providing interface functions.

12. The optical disc drive of claim 11 wherein the transmission interface is selected from the group consisting of an RS232 interface, an integrated drive electronics (IDE) interface, an enhanced IDE (EIDE) interface, a small computer system interface (SCSI) and a serial advanced technology attachment (ATA) interface.

13. The optical disc drive of claim 10 wherein the second scratch pad memory can be a dynamic random access memory (DRAM) or a cache memory.

14. A chip for upgrading an optical disc drive comprising:
a scratch pad memory comprising an activating program; and
a logic unit for loading the activating program from the scratch pad memory for performing a firmware upgrade program and storing firmware data into a flash ROM.

15. The chip of claim 14 further comprising:
a transmission interface for providing interface functions.

16. The chip of claim 15 wherein the transmission interface is selected from the group consisting of an RS232 interface, an IDE interface, an enhanced IDE (EIDE) interface, a SCSI interface and a serial ATA interface.
